(19) United States
(12) Patent Application Publication
(10) Pub. No.: US 2007/0215261 A1
(43) Pub. Date: Sep. 20, 2007

(54) Carton Gripper

(76) Inventors: Kerry Quinn, Palatine, IL (US); Adam Sloma, Arlington Heights, IL (US)

Correspondence Address: CARDINAL LAW GROUP, Suite 2000, 1603 Orrington Avenue, Evanston, IL, 60201, US

(21) Appl. No.: 11/685,547

(22) Filed: Mar. 13, 2007

Related U.S. Application Data
(60) Provisional application No. 60/782,005, filed on Mar. 14, 2006.

(51) Int. Cl. B32B 37/00

(52) U.S. Cl. 156/60; 156/538

(57) ABSTRACT

A system for applying a stamp to a pack within a carton includes a first side plate and a second side plate configured to alternate between an open configuration at a predetermined location and a closed configuration at a location based on at least one dimension of the carton. The system further includes a floor configured to alternate between an open configuration at a predetermined location and a closed configuration at a location based on at least one dimension of the carton, a mechanical lock configured to maintain the floor at an operational position when the floor is in the closed configuration, and at least one suction cup connected to a linkage, the linkage connected to one of the first side plate and second side plate, the suction cup configured to form a seal with a surface of the carton. A method is also disclosed.

### RELATED CASES

This application claims the benefit of U.S. Provisional Patent Application 60/782,005 filed Mar. 14, 2006, the entirety of which is incorporated herein by reference.

### TECHNICAL FIELD OF THE INVENTION

The present invention relates generally to conveying systems and in particular a conveying system for cigarette cartons.

### BACKGROUND OF THE INVENTION

Many jurisdictions tax the sale of cigarettes. Cigarettes are generally distributed in boxes, each box including 30 cartons of cigarettes, and each carton containing, typically, 10 packs of cigarettes, and each pack typically includes 20 cigarettes. There is no industry standard for the size of cigarettes or cartons. Therefore, cartons of cigarettes are distributed in a variety of heights and widths, depending on the brand and the dimensions of cigarettes for that brand. The packs are disposed inside each one of the cartons within an array comprising two rows of packs with each row of packs comprising five packs. In other words, the cigarette packs are disposed within an array comprising two rows and five columns.

Generally, payment of the tax is evidenced by application of a stamp to each pack of cigarettes prior to distribution to a retailer. However, cigarette manufacturers often do not know the retail destination of each carton, and therefore distribute un-stamped cartons to distributors, and the distributors apply the tax stamps. Typically, tax stamps are applied to a bottom surface of the pack. Generally speaking, then, the bottom surface of the pack, i.e. opposite the intended distribution hole for the cigarettes, is the upper surface of the pack when discussing stamping operations.

Distributors must, thus, open each carton of cigarettes, apply the correct tax stamp to each pack, and close the carton after application of the tax stamp. While these tasks can be performed manually, mechanical assistance is generally used in order to increase throughput.

Historically, an operator of the tax applicator manually adjusted the machine using a series of levers and knobs to adjust the machine to accommodate the differing dimensions of each carton due to brand variances. These machines generally include a common ceiling height and an adjustable floor. Based on the dimensions of a carton to be stamped, the adjustable floor is manually set to a height that brings the top of the carton to the common ceiling. Such machines reduce potential throughput by precluding stamping more than one height of cartons without adjustment. These machines can be advantageous when attempting to stamp a large number of cartons, but the need for mechanical adjustment makes deployment of such machines difficult in environments that feature smaller orders or require frequent changeover. An exemplary machine in accordance with this approach is disclosed in U.S. Pat. No. 4,265,355 to Davis, assigned to the assignee of this application.

Another approach is to move each station to a different height based on the height of the cartons. For example, United States Patent Application Publication 2004/0084130 to Michalski, and assigned to the assignee of this application discloses such a machine. The Michalski machine uses a series of servo motors controlled by a programmable logic controller to adjust the location of the operable stations based on a measurement made by a measuring station. Meyercord Revenue, Inc., an ITW company, markets a stamping machine incorporating the Michalski technology as the LSM stamping machine. Meyercord Revenue, Inc. further manufactures a SSM stamping machine, as well as the M120, but neither of these devices provide multiple processing paths. Meyercord Revenue, Inc. also sold a dual processing path machine called the RS2000, but the paths could not be bypassed and did not offer redundant modules. Additionally, the RS2000 featured an auxiliary mechanical plow.

Use of auxiliary mechanical plows is known in the art, but use of such plows places large mechanical loads on the cartons, especially the relatively delicate flaps. These loads, even if applied at the appropriate and desired position, can have undesired effects, such as opening the cartons at an undesired location or mechanically altering the carton or the contents of the carton. If the plow is not placed at the correct location, such as in the event of operator error or device malfunction, the carton may not properly open, or the same undesired effects can occur. Failure to open can result in application of expensive tax stamps to an external surface of a carton—an improper location requiring consumption of additional stamps and increasing costs.

Therefore, it would be desirable to provide a system for applying a stamp to packs that would overcome the aforementioned and other disadvantages.

### SUMMARY OF THE INVENTION

One aspect of the present invention provides a system for applying a stamp to packs within a carton includes a conveyor drum system. The system includes a first side plate and a second side plate configured to alternate between an open configuration at a predetermined location and a closed configuration at a location based on at least one dimension of the carton. The system further includes a floor configured to alternate between an open configuration at a predetermined location and a closed configuration at a location based on at least one dimension of the carton, a mechanical lock configured to maintain the floor at an operational position when the floor is in the closed configuration, and at least one suction cup connected to a linkage, the linkage connected to one of the first side plate and second side plate, the suction cup configured to form a seal with a surface of the carton.

Another aspect of the invention provides a method for applying a stamp to a pack within a carton. The method includes separating a first side plate and second side plate to an open configuration, translating a floor to an open configuration, and receiving the carton into the space defined by the first side plate, second side plate and floor. The method further includes translating the floor to a closed configuration in contact with the received carton, moving the first side plate and second side plate to a closed configuration in contact with the received carton, and attaching at least one suction device to the carton at an attachment surface by translating the suction device in a first direction. Furthermore, the method translates the suction device in a second direction based on the attachment and applies a stamp to a pack within the carton based on the translation of the suction device in the first direction.

Another aspect of the invention provides a system for applying a stamp to a pack within a carton. The system includes means for separating a first side plate and second side plate to an open configuration, means for translating a floor to an open configuration, and means for receiving the carton into the space defined by the first side plate, second side plate and floor. The system further includes means for translating the floor to a closed configuration in contact with the received carton, means for moving the first side plate and second side plate to a closed configuration in contact with the received carton, and means for attaching at least one suction device to the carton at an attachment surface by translating the suction device in a first direction. Furthermore, the system includes means for translating the suction device in a second direction based on the attachment and means for applying a stamp to a pack within the carton based on the translation of the suction device in the first direction.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1 illustrates a perspective view of one embodiment of a carton gripper in accordance with one embodiment of the present invention;

FIGS. 1A, 1B, and IC illustrate top, side and front views of the gripper illustrated in FIG. 1;

FIG. 2 illustrates a perspective view of a portion of the gripper of FIG. 1, in accordance with one embodiment of the present invention;

FIGS. 2A, 2B, and 2C illustrate top, side and front views of the portion of the gripper illustrated in FIG. 2;

FIG. 3 illustrates a perspective view of a portion of the gripper of FIG. 1, in accordance with one aspect of the invention;

FIGS. 3A, 3B, and 3C illustrate top, side and front views of the portion of the gripper illustrated in FIG. 3;

FIG. 4 illustrates a perspective view of a portion of the gripper of FIG. 1, in accordance with one aspect of the invention;

FIGS. 4A, 4B, and 4C illustrate top, side and front views of the portion of the gripper illustrated in FIG. 4;

FIG. 5 illustrates a perspective view of a portion of the gripper of FIG. 1, in accordance with another aspect of the invention;

FIGS. 5A, 5B, and 5C illustrate top, side and front views of the portion of the gripper illustrated in FIG. 5; and

FIG. 6 is a flowchart illustrating another method for applying a stamp to packs within a carton, in accordance with another aspect of the invention.

### DETAILED DESCRIPTION OF THE PRESENTLY PREFERRED EMBODIMENTS

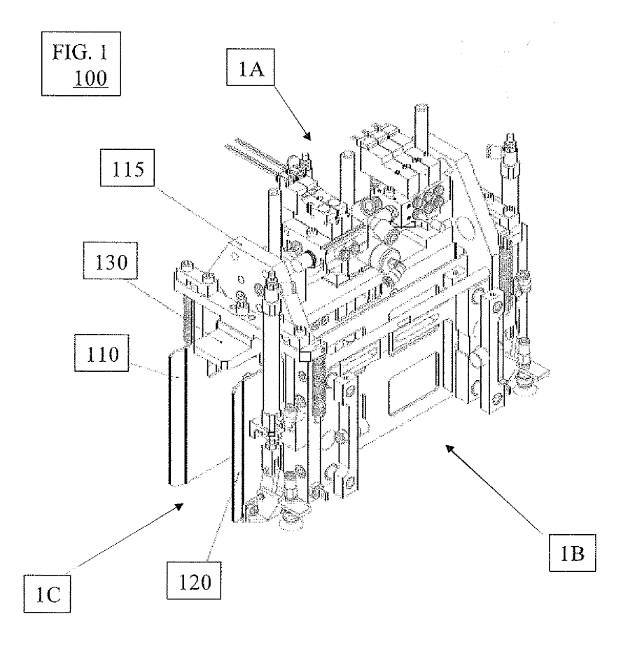

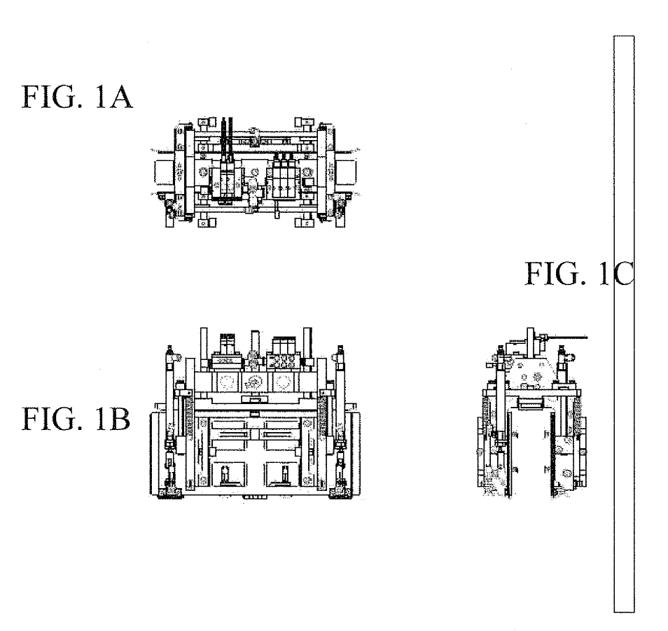

FIG. 1 illustrates one embodiment of a clamping device 100 for holding a carton for applying a stamp to packs within the carton in accordance with one embodiment of the present invention. Clamping device 100 includes first side plate 110 and second side plate 120. First side plate 110 and second side plate 120 are held in position by frame 115. Frame 115 further supports floor 130. FIGS. 1A, 1B, and IC illustrate top, side and front views of the portion of the gripper illustrated in FIG. 1.

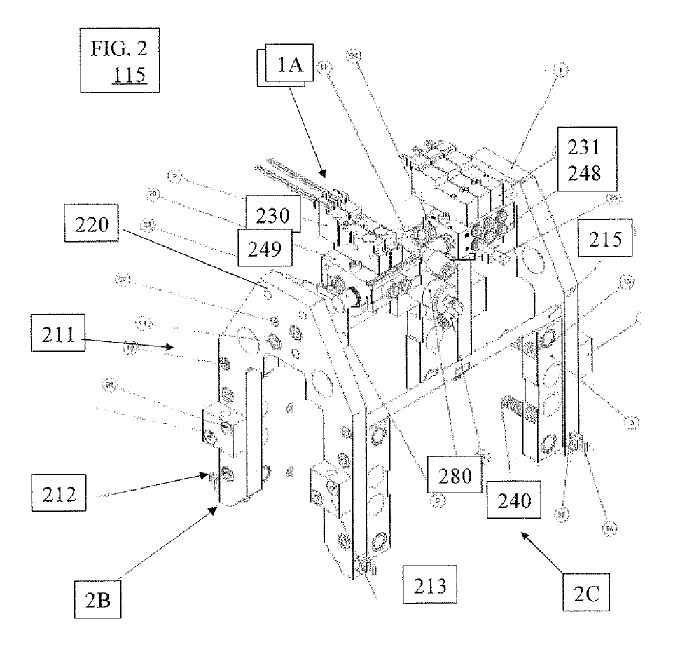

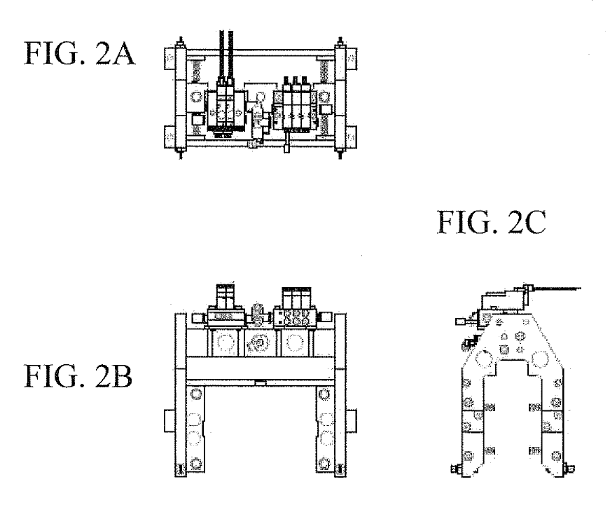

FIG. 2 illustrates one embodiment of a frame 115 for use in the clamping device 100 illustrated in FIG. 1. Frame 115 includes a first wall 120 and a second wall 220 connected with connector bar 215. Not shown in FIG. 2 is a second connector bar 215 substantially parallel to the illustrated connector bar 215. At least one solenoid valve assembly 230, 231 is attached to frame 215 and configured to open and close in order to open or close the suction devices 460, 560, discussed below.

Each of the first and second walls 210, 220 include an upper portion 211 connecting a first leg 212 and second leg 213. Compression springs 240 are mounted on a lower portion of second leg 213 and on an upper portion of second leg 213.

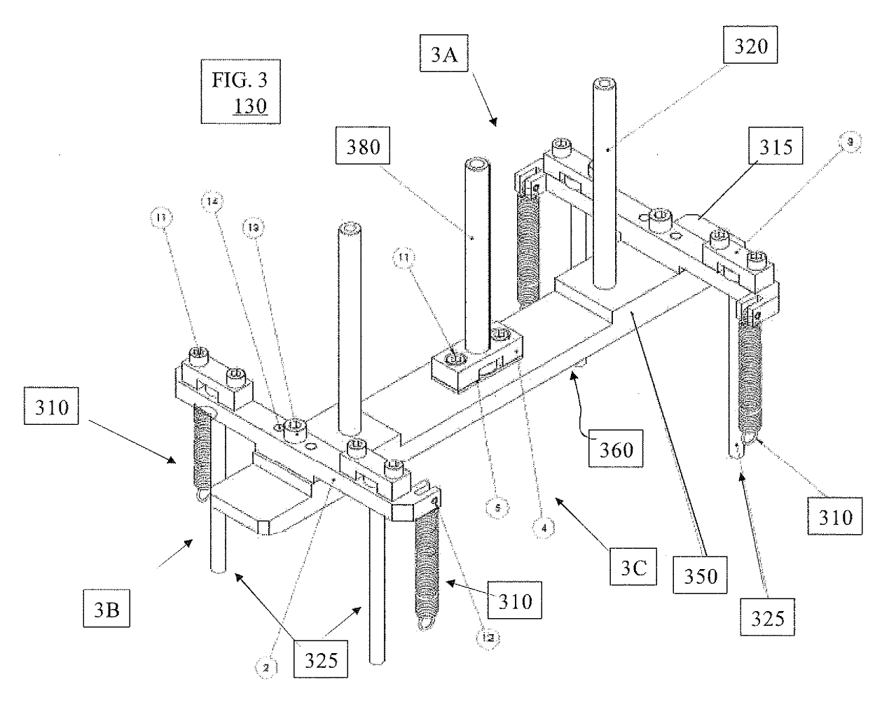

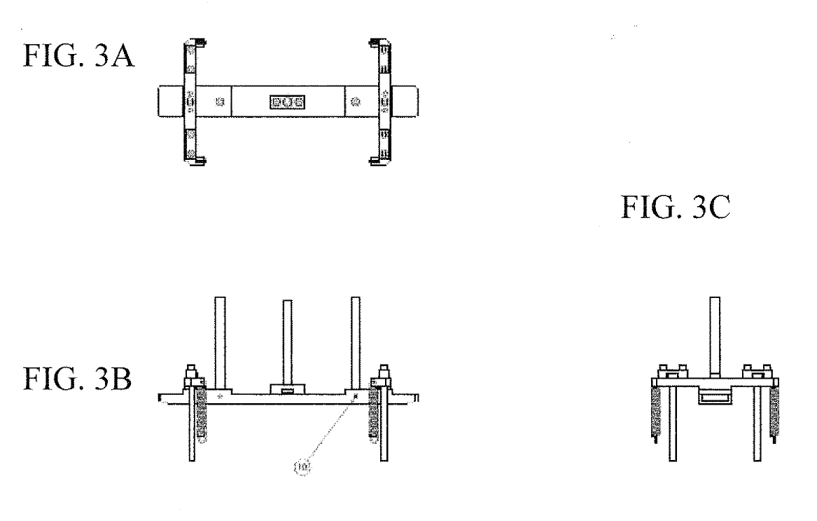

As shown in FIG. 2, solenoid valve assembly 230 includes a two-station manifold 249 and solenoid valve assembly 231 includes a three-station manifold 248. Other valve assemblies are anticipated, as well as other means for providing force to the first and second side walls. Frame 115 includes multiple valve assemblies to serve the different valve actuated systems. As will be seen in FIGS. 3-5, system 100 includes one valve actuated floor clamp (floor 130) and a valve actuated suction system (460, 560).

Clamping cartridge 280 is configured to grip pivot pin 380 of floor plate 310, shown in FIG. 3. FIGS. 2A, 2B, and 2C illustrate top, side and front views of the portion of the gripper illustrated in FIG. 2.

FIG. 3 illustrates one example of a floor 130 in accordance with one aspect of the invention. Floor 130 includes a plurality of extension springs 310 connected to floor frame 315. Floor frame 315 connects to at least one post 320 configured to mate with a reception hole (not shown) of frame 115. Floor frame 315 further connects with a plurality of pins 325. Posts 320 and pins 325 extend in generally opposing directions. Floor 130 further includes floor plate 350, including a floor surface 360. Pivot pin 380 connects to floor plate 350 at a side opposing surface 360, and provides a structure to receive the clamping force applied by clamping cartridge 280. FIGS. 3A, 3B, and 3C illustrate top, side and front views of the portion of the gripper illustrated in FIG. 3.

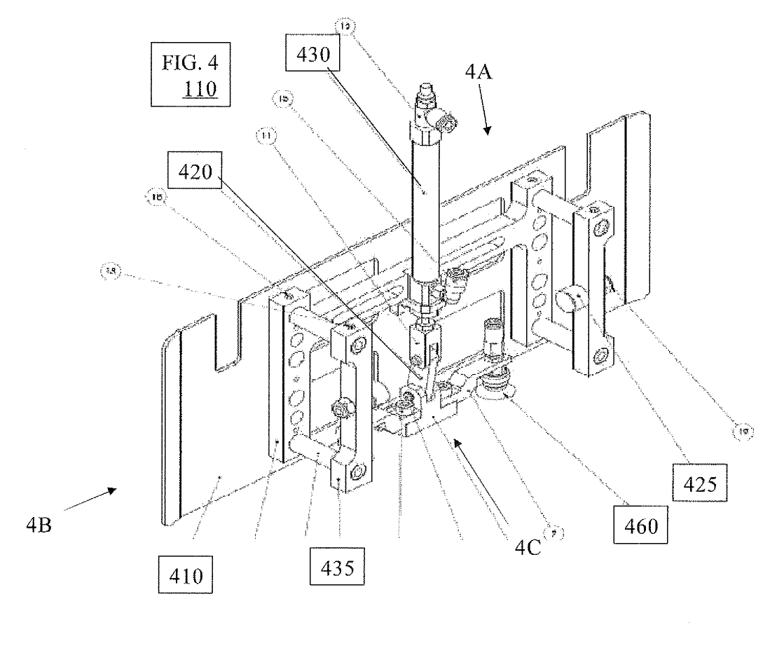

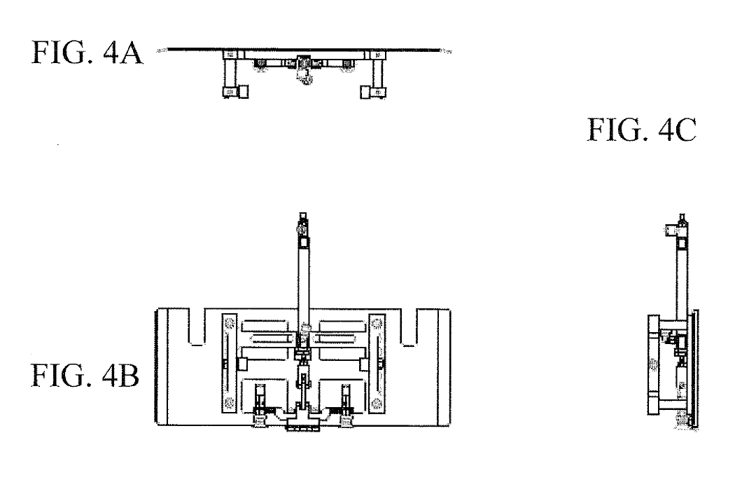

FIG. 4 illustrates one example of a first side plate 110 in accordance with one aspect of the invention. First side plate 110 includes plate 410 and suction device 460. Suction device 460 is connected to suction frame 435 near a middle of the first side plate 110. Suction frame 435 is configured to be driven by linkage 420. Linkage 420 connects suction frame 435 with air cylinder 430 for pneumatic operations. For hydraulically driven applications, linkage 420 connects to hydraulic devices. Cam follower 425 attaches to wall frame 435 and connects to plate 410 via frame 435. Not shown is a connection between cylinder 430 and the solenoid valve assemblies 230, 231 that drive the cylinder. FIGS. 4A, 4B, and 4C illustrate top, side and front views of the portion of the gripper illustrated in FIG. 4.

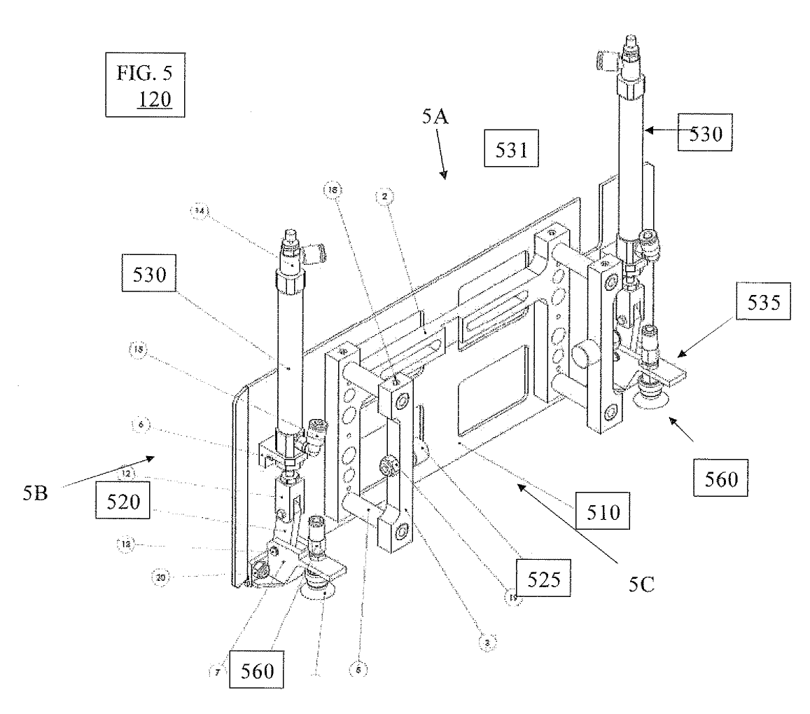

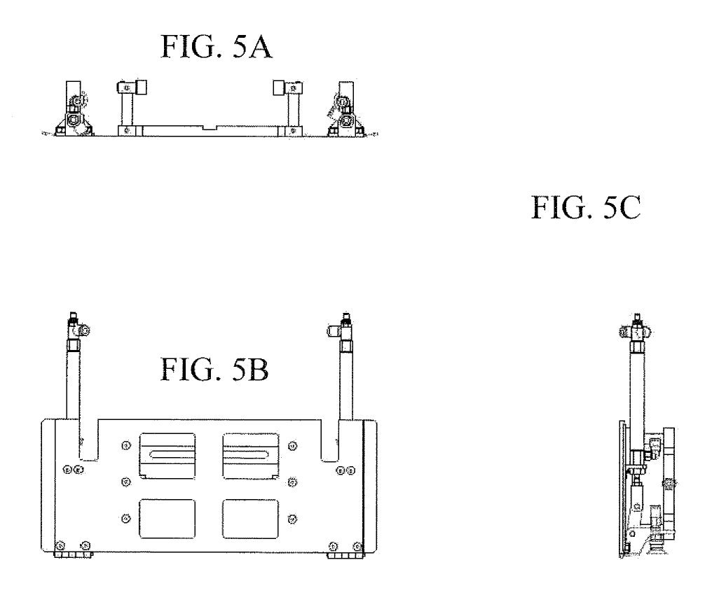

FIG. 5 illustrates one example of a second side plate 120 in accordance with one aspect of the invention. Second side plate 120 includes plate 510 and a plurality of suction devices 560. Suction devices 560 connect to suction frame 535 and to linkage 520. As shown, suction devices 560 are disposed at opposing ends of second side plate 120. Air cylinder 530 drives linkage 520 to move suction devices 560. As shown, a pneumatic system is used, but any appropriate driving means can be used, including hydraulic or electrical. Cam follower 525 connects to frame 531 and to plate 510. FIGS. 5A, 5B, and 5C illustrate top, side and front views of the portion of the gripper illustrated in FIG. 5.

First side plate 110 and second side plate 120 are configured to alternate between an open configuration and a closed configuration. The open configuration is defined by the maximum travel allowed by frame 115, which is a predetermined location based on the dimensions of frame 115. The closed configuration is defined by dimensions of a carton loaded between first side plate 110 and second side plate 120. A cam interfaces with cam followers 425, 525 to mechanically move first side plate 110 and second side plate 120 to the open configuration, in the embodiments illustrated herein. It is also anticipated that the first side plate 110 and second side plate 120 can be driven to the open configuration hydraulically, pneumatically, or with other power sources, such as a motor. Compression springs 240 operate to move the first side plate 110 and second side plate 120 to the closed configuration upon release of the cam. Preferably, the compression springs are configured to have sufficient compressive force to maintain the gripped carton in place, without damaging or deforming the carton or the contents of the carton. In one embodiment, at least one pair of matched springs are used.

Floor 130 is configured to alternate between an open configuration at a predetermined location and a closed configuration at a location based on at least one dimension of the carton. The open configuration is defined by the maximum travel allowed by frame 115, which is a predetermined location based on the dimensions of frame 115. Extension springs bias floor plate 350 such that surface 360 moves the carton to interface with a ceiling plate defining the operational vertical position of the carton. By biasing the carton against the ceiling plate with the extension springs, the packs within the carton are placed at the desired location to receive stamps.

Suction devices 460, 560 are attached to driven linkages 420, 520 to move along an arcuate path between an open configuration and a closed configuration. When the suction devices 460, 560 are in the closed configuration, each suction device forms a seal with a surface of the carton. Therefore, translating the suction devices in a first direction results in formation of a seal with a surface of the carton, while reversing the translation to move the suction devices in a second direction opposing the first direction opens the carton.

A mechanical lock is configured to maintain the floor at an operational position when the floor is in the closed configuration. The mechanical lock illustrated here includes clamping cartridge 280 and pivot pin 380, although other locking mechanisms are contemplated.

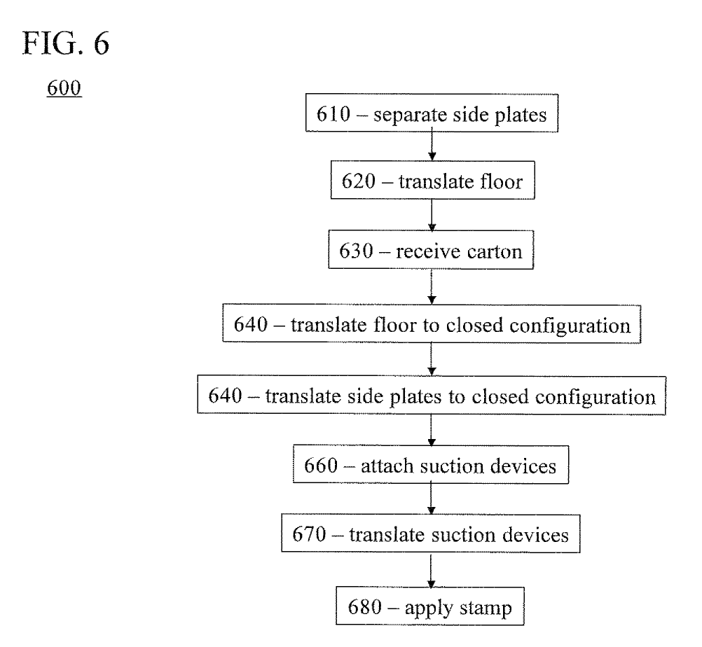

FIG. 6 illustrates one embodiment of a method 600 for gripping a carton in accordance with one aspect of the invention. Method 600 begins by separating a first side plate and second side plate to an open configuration at step 610. The separation can be based on mechanical action, such as cam action. In the event that a carton was previously gripped within the first and second side arms, this motion releases the carton. This step occurs at a loading station.

Based on the separation of the first and second side plates, a floor is translated to an open configuration at step 620. The floor can be translated by biasing the floor with spring elements, or by mechanical movements, such as via a cam system, or via pneumatic or hydraulic mechanisms.

Having positioned the first side plate, second side plate, and floor into an open configuration, a carton is received in the space defined by the first side plate, second side plate, and floor at step 630. The carton is, for example, received from a conveyor.

After receiving the carton, the floor is translated to a closed configuration in contact with the received carton at step 640. The floor biases the received carton against a fixed structure, such as a ceiling plate to place the carton at an operational position. In one example, removal of a mechanical force applied to the floor to maintain the floor in the open configuration allows at least one spring to translate the position of the floor. After moving the floor to the closed position, a mechanical lock is actuated to maintain the floor in the closed configuration at step 650.

After engaging the lock, the cam actuation is removed from the first and second side plates, removing the forces maintaining the first and second side plates in the open configuration at step 660. The removal of such force allows the first and second side plates to move to a closed configuration in contact with the received carton. For example, the first and second side plates can be biased by at least one spring. The carton is gripped in a preferred centered position at the preferred height.

Having moved the first and second side plates to the closed configuration, and the floor to the closed configuration, the carton is now effectively held in an operational position by the floor, and gripped by the first and second side plates. Based on this grip, the carton with the gripping first and second side plates is translated away from the loading station, and away from the ceiling plate. In one embodiment, the translation occurs by rotation of a conveyor drum, such as the drum disclosed in U.S. patent application Ser. No. ______ (atty docket 20116 1231/12), the entirety of which is incorporated herein by reference.

Having moved the carton away from the ceiling plate, at least one suction device is attached to an attachment surface, such as a flap, of the carton at step 670. In one embodiment, the suction device is connected to a linkage driven by a piston. Attaching the suction device to the attachment surface includes forming a seal with the surface. Attaching the suction device includes translating the suction device in a first direction.

Having formed a seal with the surface, the suction device is then translated in a second direction opposite the first direction. This motion is based on, for example, reversing the linkage. Translating the suction device in this second direction results in the attachment surface being lifted. For example, the movement results in opening a flap. In the event that an adhesive was previously used to connect the flaps of the carton, an edged surface is translated below the attachment surface based on the translation of the suction device in the first direction, and prior to translation in the second direction, to cut the adhesive material.

In one embodiment, two sets of suction devices are used to open the carton. A first set of suction devices is attached to an outer flap, and the movement is reversed to lift the outer flap, exposing an inner or lower flap. The second set of suction devices is then attached to the inner flap, and the movement is reversed to lift the inner flap, exposing the packs within the carton.

After opening the carton, at least one tax stamp is applied to a pack within the opened carton at step 680. The stamp can be applied using known systems, or a system based on the disclosures of U.S. patent application Ser. No. ______ (20109 1231/9), the entirety of which is incorporated herein.

Having applied the stamp, the suction devices are then translated back in the first direction to close the carton. In embodiments featuring two sets of suction devices, the inner flap is first closed, followed by the outer flap. In one embodiment, an adhesive is applied to an upper surface of the inner flap prior to closing the outer flap. Having closed the carton, the suction device/s are released. The carton is moved back to the loading station, and released based on the release of the suction device/s.

Gripping a carton in this fashion allows a conveyor drum to be used to stamp packs, as disclosed in U.S. patent application Ser. No. ______ (atty docket 20116 1231/12), the entirety of which is incorporated by reference. Furthermore, the grippers adjust to the size of the cartons without measuring the dimensions of the carton, or manually adjusting a machine, and the integrated suction devices obviate the need for a plow to open the carton. Therefore, a stamping machine can efficiently process a mix of incoming carton sizes with a reduced operator input.

It is important to note that the figures and description illustrate specific applications and embodiments of the present invention, and is not intended to limit the scope of the present disclosure or claims to that which is presented therein. Upon reading the specification and reviewing the drawings hereof, it will become immediately obvious to those skilled in the art that myriad other embodiments of the present invention are possible, and that such embodiments are contemplated and fall within the scope of the presently claimed invention.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A system for applying a stamp to a pack within a carton, the system comprising:
a first side plate and a second side plate, the first side plate and second side plate configured to alternate between an open configuration at a predetermined location and a closed configuration at a location based on at least one dimension of the carton;
a floor configured to alternate between an open configuration at a predetermined location and a closed configuration at a location based on at least one dimension of the carton;
a mechanical lock configured to maintain the floor at an operational position when the floor is in the closed configuration; and
at least one suction cup connected to a linkage, the linkage connected to one of the first side plate and second side plate, the suction cup configured to form a seal with a surface of the carton.

2. The system of claim 1 wherein the first side plate and second side plate alternate between the open configuration and closed configuration responsive to a cam actuation.

3. The system of claim 2 wherein the first side plate and second side plate are spring loaded by at least one pair of matched springs acting against the cam actuation.

4. The system of claim 3 wherein the matched springs are compression springs.

5. The system of claim 1 wherein the floor is spring loaded by at least one extension spring.

6. A method for applying a stamp to a pack within a carton, the method comprising:
separating a first side plate and second side plate to an open configuration;
translating a floor to an open configuration;
receiving the carton into the space defined by the first side plate, second side plate and floor;
translating the floor to a closed configuration in contact with the received carton;
moving the first side plate and second side plate to a closed configuration in contact with the received carton;
attaching at least one suction device to the carton at an attachment surface by translating the suction device in a first direction;
translating the suction device in a second direction based on the attachment, and;
applying a stamp to a pack within the carton based on the translation of the suction device in the second direction.

7. The method of claim 6 wherein the first plate and side plate are separated using mechanical action.

8. The method of claim 7 wherein the first plate and second side plate are moved to the closed configuration by removing the mechanical action.

9. The method of claim 6 wherein translating the floor to a closed configuration in contact with the received carton comprises translating the carton to contact a ceiling plate defining an operational position of the carton.

10. The method of claim 6 further comprising:
releasing the suction device based on the translation.

11. The method of claim 10 further comprising:
releasing the carton based on the release of the suction device.

12. The method of claim 6 further comprising:
translating an edged surface below a surface of the carton based on the translation of the suction device in a first direction to cut any adhesive material disposed about the surface.

13. The method of claim 6 further comprising:
applying a mechanical lock to the floor based on the translation to the closed configuration.

14. A system for applying a stamp to a pack within a carton, the system comprising:
means for separating a first side plate and second side plate to an open configuration;
means for translating a floor to an open configuration;
means for receiving the carton into the space defined by the first side plate, second side plate and floor;
means for translating the floor to a closed configuration in contact with the received carton;
means for moving the first side plate and second side plate to a closed configuration in contact with the received carton;
means for attaching at least one suction device to the carton at an attachment surface;
means for translating the suction device in a first direction to apply force to the attachment surface and
means for applying a stamp to a pack within the carton based on the translation of the suction device in the second direction.
